(19) United States
(12) Patent Application Publication
(10) Pub. No.: US 2004/0025542 A1
(43) Pub. Date: Feb. 12, 2004

(54) Method of making extreme ultraviolet lithography glass substrates

(76) Inventors: Laura J. Ball, Fontaine le Port (FR); Sylvain Rakotoarison, Avon (FR)

Correspondence Address: CORNING INCORPORATED, SP-TI-3-1, CORNING, NY, 14831

(21) Appl. No.: 10/456,318

(22) Filed: Jun. 5, 2003

Related U.S. Application Data
(60) Provisional application No. 60/392,486, filed on Jun. 28, 2002.

(30) Foreign Application Priority Data
Jun. 7, 2002 (FR) 02 07034

(51) Int. Cl. C03B 19/06; C03B 37/018

(52) U.S. Cl. 65/391; 65/17.4

(57) ABSTRACT

A method for making extreme ultraviolet lithography tool glass substrates includes generating a plasma, delivering reactants comprising a silica precursor and a titania precursor into the plasma to produce titania and silica particles, and depositing the titania and silica particles on a deposition surface to form a homogeneous titania-doped silica. The invention provides for homogeneous glass substrates that are free of striae variations and provides for beneficial extreme ultraviolet lithography reflective optics.

### CROSS-REFERENCE TO RELATED APPLICATIONS

The present application claims priority under 35 U.S.C. §119 to French Patent Application No. 02 07034, filed Jun. 7, 2002; and to U.S. Provisional Patent Application No. 60/392,486, filed Jun. 28, 2002, each of which is incorporated herein by reference in its entirety.

### BACKGROUND OF INVENTION

1. Field of the Invention

The invention relates generally to projection lithographic methods and systems for producing integrated circuits and forming patterns with extremely small feature dimensions. The invention relates particularly to a method for making thermally-stable extreme ultraviolet lithography structure objects such as optical mirror element substrate structures and reflective substrate structures. The invention relates particularly to a method for producing titania-doped silica glass and use of the titania-doped glass in fabricating extreme ultraviolet lithography structure objects.

2. Background Art

Extreme ultraviolet lithography is emerging as one of the next-generation lithography techniques that will allow high-volume production of integrated circuits with sub-100-nm features. Extreme ultraviolet lithography as currently contemplated involves producing electromagnetic radiation at around 13 nm. The extreme ultraviolet radiation may be produced, for example, using a 1064-nm neodymium-YAG laser, which produces a xenon gas plasma, a synchrotron source, discharge pumped x-ray lasers, or an electron-beam driven radiation source. FIG. 1 shows a schematic of an extreme ultraviolet lithography imaging system 1. As shown, a condenser system, including mirrors 2, collects, shapes, and filters radiation from an extreme radiation source 3 to achieve a highly uniform intense beam. The beam is projected onto a mask 4 containing a pattern to be replicated on a silicon wafer 5. The mask 4 reflects the extreme ultraviolet radiation into a reduction imaging system including an assembly of reflective mirrors 6. The reflective mirrors 6 image the mask pattern and focus the mask pattern onto a resist-coated silicon wafer 5. The pattern is later transferred to the silicon wafer by etching.

FIG. 2 shows a cross-sectional view of a typical mask structure. As shown, the mask structure includes a substrate 8, a reflective multilayer stack 9 formed on the substrate 8, and an absorber 10 formed on the reflective multilayer stack 9. Typically, the reflective multilayer stack 9 includes alternating layers of Mo and Si or Mo and Be. The absorber 10 defines the pattern to be replicated on a silicon wafer. The mask blank 8 may be made of silicon or glass or other suitable material. However, it is important that the material used for the mask blank 8 has a low coefficient of thermal expansion so that the mask blank 8 does not distort under exposure to the extreme ultraviolet radiation. It is also important that the material used for the mask blank 8 has low absorption at the exposure wavelength. Otherwise, the mask blank 8 could heat up and cause distortion and pattern placement errors at the wafer.

Titania-doped silica glass can be made to have a very low coefficient of thermal expansion, i.e., lower than pure fused silica with the potential for a coefficient of thermal expansion that approximates zero. Titania-doped silica glass is commercially produced by the boule process. The boule process involves passing a mixture of a silica precursor and a titania precursor into a flame of a burner to produce titania-doped silica soot. The soot is then directed downwardly into a refractory cup at consolidation temperatures, typically 1200 to 1900° C., so as to allow the silica particles to immediately consolidate into a dense glass. The glass can be used as a mask blank at appropriate wavelengths. However, it is difficult to achieve a glass with a uniform composition using the boule process. Compositional variations in the glass would result in the glass having non-uniform thermal expansion properties. Extreme ultraviolet lithography requires very low variations in coefficient of thermal expansion within the glass, e.g., 0±5 ppb/° C. Therefore, a method for producing titania-doped silica glass that favors homogeneity in the glass is desirable.

### SUMMARY OF INVENTION

In one aspect, the invention relates to a method for making titania-doped silica which comprises generating a plasma, delivering reactants comprising a silica precursor and a titania precursor into the plasma to produce titania and silica particles, and depositing the particles on a deposition surface to form a homogeneous titania-doped silica.

In another aspect, the invention relates to a method for making titania-doped silica which comprises generating a plasma, delivering reactants comprising a chlorine-free silica precursor and a chlorine-free titania precursor into the plasma to produce titania and silica particles, and depositing the particles on a deposition surface to form a homogeneous titania-doped silica.

In another aspect, the invention relates to a method for forming an extreme ultraviolet lithography glass substrate which comprises generating a plasma, delivering reactants comprising a silica precursor and a titania precursor into the plasma to produce titania and silica particles, and consolidating the titania and silica particles into a homogeneous titania-doped silica glass having a dopant level in a range from 6 to 9% by weight and a homogeneous coefficient of thermal expansion in a range from +30 to −30 ppb/° C. at 20-25° C.

In another aspect, the invention relates to a method for forming a lithography glass substrate which comprises generating a plasma, delivering reactants comprising a silica precursor and a titania precursor into the plasma to produce titania and silica particles, and consolidating the titania and silica particles into a homogeneous titania-doped silica glass having a dopant level in a range from 6 to 9% by weight and a homogeneous coefficient of thermal expansion in a range from +30 to −30 ppb/° C. at 20-25° C.

In another aspect, the invention relates to a mask blank for extreme ultraviolet lithography produced by a method comprising generating a plasma, delivering reactants comprising a silica precursor and a titania precursor into the plasma to produce titania and silica particles, depositing the particles on a deposition surface, consolidating the particles into glass, and finishing the glass into a mask blank.

Other features and advantages of the invention will be apparent from the following description and the appended claims.

### BRIEF DESCRIPTION OF DRAWINGS

FIG. 1 is a schematic of an extreme ultraviolet lithography system.

FIG. 2 is a cross-sectional view of the mask shown in FIG. 1.

FIG. 3 illustrates a system for producing titania-doped silica glass by plasma induction.

FIG. 4 shows a distribution system for distributing a silica precursor to the injector shown in FIG. 3.

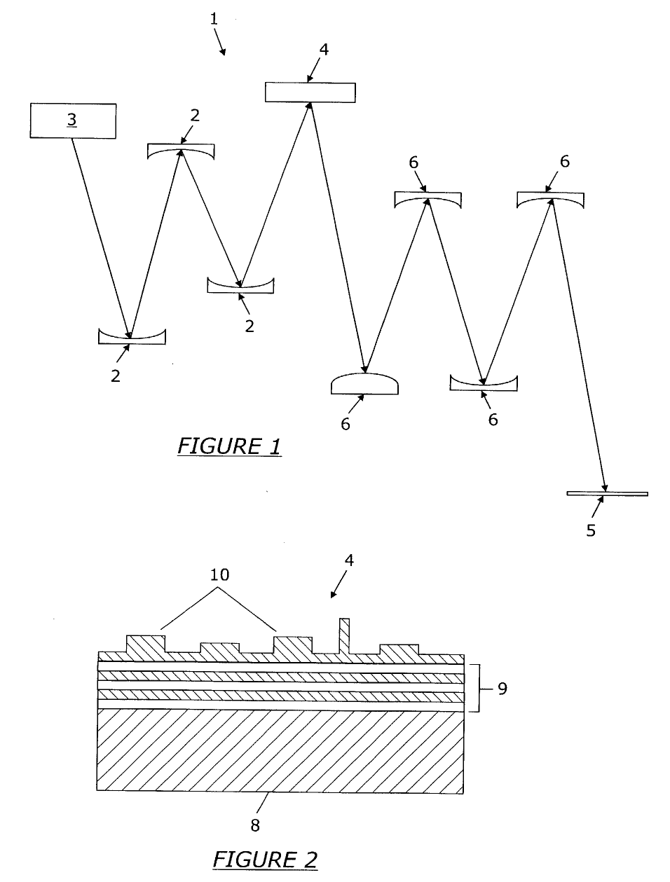

### DETAILED DESCRIPTION

Embodiments of the invention provide a method for producing a titania-doped silica glass with uniform composition using plasma induction. The glass produced by the method of the invention is striae-free and therefore avoids the striae problem seen when glass produced by the boule process is formed, i.e., ground and polished, into a curved mirror surface that cuts across the planar striae levels. The glass produced by the method of the invention has a low coefficient of thermal expansion and is therefore useful in making extreme ultraviolet lithography structure objects such as optical mirror element substrate structures and reflective mask element substrate structures. PCT patent publications WO0108163 A1 (“EUV Soft X-ray Projection Lithographic Method System and Lithography Elements” by Davis et al. of Corning Incorporated) and WO0107967 A1 (“EUV Soft X-ray Projection Lithographic Method and Mask Devices” by Davis et al. of Corning Incorporated), hereby incorporated by reference, show extreme ultraviolet lithography mirror element and mask structures. The method of the invention can also be used to produce a water-free, titania-doped silica glass, which can be used as lens material at vacuum ultraviolet wavelengths, i.e., below 157 nm.

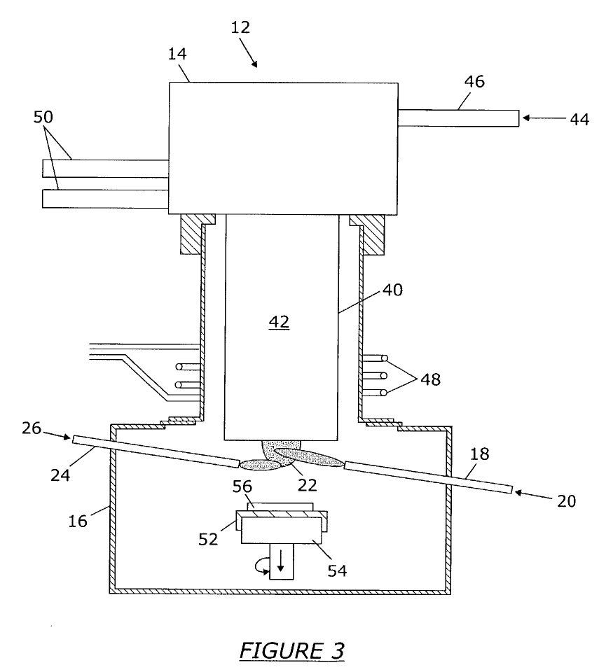

Specific embodiments of the invention will now be described with reference to the accompanying drawings. FIG. 3 illustrates a system 12 for making titania-doped silica glass by plasma induction according to one embodiment of the invention. The system 12 includes an induction plasma torch 14 mounted on a reactor 16, e.g., a water-cooled, stainless reactor. The plasma torch 14 can be a cold cage torch made of copper or quartz. The system 12 also includes an injector 18 for injecting silica precursor 20 into a plasma flame 22. In the illustrated embodiment, the injector 18 is inserted through a lateral side of the reactor 16 to project the silica precursor 20 into the plasma flame 22. Alternatively, the injector 18 may be inserted through the plasma torch 14 to deposit the silica precursor 20 through the center of the plasma flame 22. The system 12 also includes an injector 24 for injecting titania precursor 26 into the plasma flame 22. In the illustrated embodiment, the injector 24 is inserted through a lateral side of the reactor 16 to project the titania precursor 26 into the plasma flame 22. In alternate embodiments, the titania precursor 26 may be mixed with the silica precursor 20, and the mixture may be delivered into the plasma flame 22 by the injector 18. If necessary, an oxidant may also be delivered to the plasma flame 22 using any of the injectors 18 and 24.

The silica precursor 20 and titania precursor 26 may be deposited in the plasma flame 22 in vapor, liquid, or solid form. The silica precursor 20 can be any compound containing silicon, such as SiCl₄ or octamethylcyclotetrasiloxane (OMCTS). The titania precursor 26 can be any compound containing titanium, such as titanium isoproxide or TiCl₄. However, it is usually desirable to use a silica precursor and a titania precursor that is free of chlorine because chlorine is harmful to the environment and causes absorption at low wavelengths. It is also desirable to use precursors that do not polymerize during the process. To produce a water-free silica glass, it is desirable to use a silica precursor and a titania precursor that is free of hydrogen. In a preferred embodiment, the silica precursor 20 is silica powder, and the titania precursor 26 is titania powder. The nominal grain size of the silica powder and titania powder can range from 0.1 to 300 μm. Natural or synthetic quartz may also be used as the silica precursor.

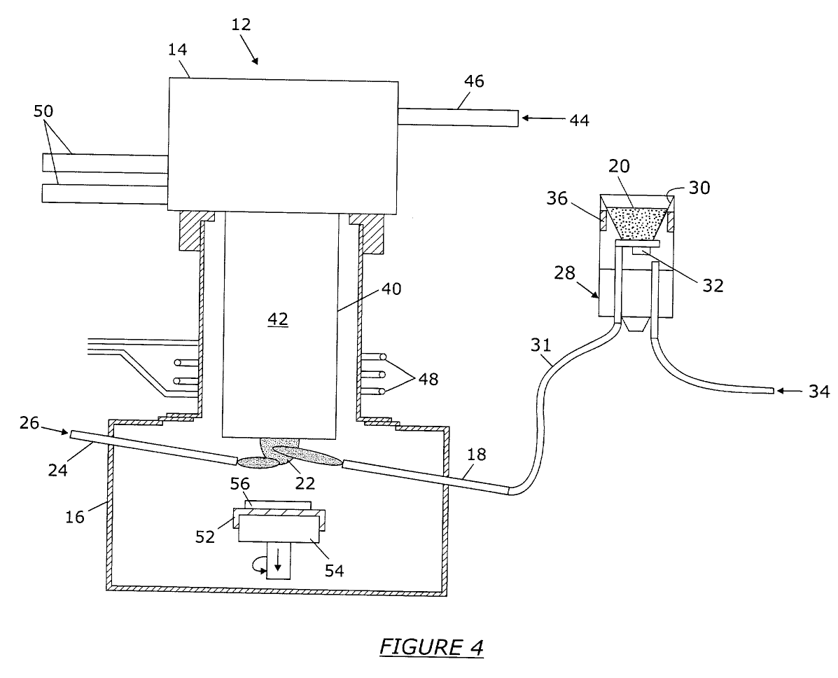

FIG. 4 shows a distribution system 28 for distributing silica powder 20 to the injector 18. The distributor system 28 includes a container 30 for holding the silica powder 20. The container 30 is connected to the injector 18 via a feed line 31. The container 30 is mounted on a vibrator 32 that controls the rate at which the powder 20 is supplied to the injector 18. Gas flow 34 creates pressure in the distribution system 28, which assists in transporting the silica powder 20 to the injector 18. A heating ring 36 heats the container 30 so that the silica powder 20 is maintained in a dry condition. Although not shown, a similar distribution system is provided for distributing titania powder 26 to the injector 24. The distribution system could also maintain the titania powder 26 in a dry condition. This allows an essentially water-free glass to be produced. It should be noted that different distribution systems are needed if the silica precursor and titania precursor are in liquid or vapor form.

The plasma torch 14 includes a reaction tube 40 that defines a plasma production zone 42. The reaction tube 40 may be made of high-purity silica or quartz glass to avoid contaminating the silica glass with impurities. In operation, plasma-generating gases 44 are introduced into the plasma production zone 42 through a feed duct 46. Examples of plasma-generating gases 44 include argon, oxygen, air, and mixtures of these gases. An induction coil 48 surrounding the reaction tube 40 generates high-frequency alternating magnetic field within the plasma production zone 42 which ionizes the plasma-generating gases 44 to produce the plasma flame 22. The induction coil 48 is connected to a high-frequency generator (not shown). Water coolers 50 are used to cool the plasma torch 14 during the plasma generation. The injectors 18 and 24 project the silica precursor 20 and titania precursor 26 into the plasma flame 22. The silica precursor 20 and titania precursor 26 are converted to fine titania-doped silica particles in the plasma flame 22.

The titania and silica particles are deposited on a substrate 52. Typically, the substrate 52 is made of high-purity silica. The substrate 52 is mounted on a rotating table 54, which allows the silica particles to be deposited evenly on the substrate 52. The rotating table 52 is located within the reactor 16. The atmosphere in the reactor 16 is controlled and sealed from the surrounding atmosphere so that a glass that is substantially free of water can be produced. In one embodiment, the atmosphere in the reactor 16 is controlled so that a water vapor content in the reactor is less than 1 ppm by volume. This can be achieved by purging the reactor 16 with an inert gas or dry air and/or using a desiccant, such as zeolite, to absorb moisture. In one embodiment, the plasma flame 22 heats the substrate 52 to consolidation temperatures, typically 1500 to 1800° F. so that the titania-doped silica particles deposited on the substrate 52 immediately consolidate into glass 56. In other embodiments, the titania-doped silica particles deposited on the substrate 52 may be consolidated into glass in a separate step.

The plasma induction process allows uniform doping of the silica with titania prior to deposition on the substrate 52. Preferably, the homogeneous titania-doped silica glass produced by the plasma induction process has a titania dopant level in the range from 6 to 9% by weight and a coefficient of thermal expansion (CTE) in the range from +30 ppb/° C. to −30 ppb/° C. at 20-25° C., more preferably +20 ppb/° C. to −20 ppb/° C. at 20-25° C., with a CTE variation preferably lower than 10 ppb/° C. Preferably, the titania dopant level in the titania-doped silica particles and the consolidated titania-doped silica glass is in the range from 6 to 8% by weight, more preferably 6.8 to 7.5% by weight, and the CTE is in the range from +10 ppb/° C. to −10 ppb/° C. at 20-25° C., with a CTE variation preferably lower than 5 ppb/° C. For extreme ultraviolet lithography substrates, the homogeneous titania-doped silica glass preferably has a titania dopant level in the range from 6% to 9% by weight and has a coefficient of thermal expansion in the range from +30 ppb/° C. to −30 ppb/° C. at 20-25° C., more preferably +20 ppb/° C. to −20 ppb/° C. at 20-25° C., more preferably +10 ppb/° C. to −10 ppb/° C. at 20-25° C., and more preferably +5 ppb/° C. to −5 ppb/° C. at 20-25° C., with a variation in CTE less than 10 ppb/° C.

The titania dopant level in the glass or soot can be adjusted by changing the amount of the titania precursor 26 delivered to the plasma flame 22. Other dopants, such as fluorinated gases and compounds capable of being converted to an oxide of B, F, Al, Ge, Sn, P, Se, Er, or S, may be delivered to the plasma flame 22 together with the silica precursor 20 and titania precursor 26. These dopants can be deposited in the plasma flame 22 using either of the injectors 18 or 24 or a separate dopant feed. Examples of fluorinated gases include, but are not limited to, CF₄, chlorofluorocarbons, e.g., CFₓCl₄₋ₓ, where x ranges from 1 to 3, NF₃, SF₆, and SiF₄. The glass formed by the process above can be used as mask blank or lens material. Finishing of the glass may include cutting the glass into a desired shape, polishing the surfaces of the glass, and cleaning the glass.

The invention provides one or more advantages. The titania-doped silica glass produced by the method of the invention has a uniform composition, a low variation in coefficient of thermal expansion, and a low CTE. Therefore, the titania-doped silica glass is suitable for use as mask blank for reflective masks used in extreme ultraviolet lithography tools. The titania-doped silica glass is also suitable as lens material for extreme ultraviolet lithography tools and for other applications operating at wavelengths of 157 mn and shorter. Water-free titania-doped silica glass can be made using the process described above. The titania-doped silica glass can be produced in one step, i.e., deposition and consolidation into glass can be achieved at the same time. Precursors can be used in liquid, gas, or solid form. There is less contamination if the plasma torch is made out of quartz.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for forming a lithography glass substrate, comprising:
generating a plasma;
delivering reactants comprising a silica precursor and a titania precursor into the plasma to produce titania and silica particles; and
consolidating the titania and silica particles into a homogeneous titania-doped silica glass having a titania dopant level in a range from 6 to 9% by weight and a homogeneous coefficient of thermal expansion in a range from +30 to −30 ppb/° C. at 20-25° C.

2. The method of claim 1, wherein the titania dopant level is in a range from 6 to 8% by weight.

3. The method of claim 1, wherein the titania dopant level is in a range from 6.8 to 7.5% by weight.

4. The method of claim 1, wherein the homogeneous titania-doped silica glass has a homogeneous coefficient of thermal expansion in the range of +20 to −20 ppb/° C. at 20-25° C.

5. The method of claim 1, wherein the homogeneous titania-doped silica glass has a variation in coefficient of thermal expansion less than 10 ppb/° C.

6. The method of claim 1, further comprising the step of finishing the homogeneous titania-doped silica glass into a mask blank.

7. A method for making titania-doped silica, comprising:
generating a plasma;
delivering reactants comprising a silica precursor and a titania precursor into the plasma to produce titania and silica particles; and
depositing the titania and silica particles on a deposition surface to form a homogeneous titania-doped silica having 6 to 9 wt % titania.

8. The method of claim 7, wherein the silica precursor comprises silica powder.

9. The method of claim 8, wherein the titania precursor comprises titania powder.

10. The method of claim 9, wherein a nominal grain size of the silica powder and titania powder ranges from 0.1 to 300 μm.

11. The method of claim 7, wherein the silica precursor comprises natural quartz.

12. The method of claim 7, wherein the silica precursor comprises synthetic quartz.

13. The method of claim 7, wherein depositing the titania and silica particles on the deposition surface comprises simultaneously consolidating the titania and silica particles into a homogeneous titania-doped silica glass.

14. The method of claim 13, wherein the step of depositing the titania and silica particles on the deposition surface includes rotating the deposition surface.

15. The method of claim 13, wherein the homogeneous titania-doped glass has a homogeneous coefficient of thermal expansion in a range from +30 ppb/° C. to −30 ppb/° C. at 20-25° C.

16. The method of claim 13, wherein the titania-doped silica glass has a variation in coefficient of thermal expansion less than 10 ppb/° C.

17. The method of claim 7, further comprising consolidating the titania and silica particles into the homogeneous titania-doped silica glass.

18. The method of claim 7, wherein the reactants further comprise a compound capable of being converted to an oxide of at least one member of the group consisting of B, Al, Ge, Sn, P, Se, Er, and S.

19. The method of claim 7, wherein the reactants further comprise a fluorine compound selected from the group consisting of CFₓCl₄₋ₓ, where x ranges from 1 to 3, NF₃, SF₆, and SiF₄.

20. The method of claim 7, wherein the plasma is generated by induction with a high frequency generator.

21. The method of claim 7, wherein the titania and silica particles are deposited on the deposition surface in an enclosure having a water vapor content less than 1 ppm by volume.

22. A method for making titania-doped silica, comprising:
generating a plasma;
delivering reactants comprising a chlorine-free silica precursor and a chlorine-free titania precursor into the plasma to produce titania and silica particles; and
depositing the particles on a deposition surface to form a homogeneous titania-doped silica.
